(19) United States
(12) Patent Application Publication
(10) Pub. No.: US 2026/0119397 A1
(43) Pub. Date: Apr. 30, 2026

(54) DYNAMIC L1 CACHE RECONFIGURATION

(71) Applicant: NVIDIA Corporation, Santa Clara, CA (US)

(72) Inventors: Lixia Qin, Shanghai (CN); Sandeep Suresh Navada, San Jose, CA (US); Gregory Scott Palmer, Cedar Park, TX (US); Rajballav Dash, San Jose, CA (US); Gentaro Hirota, San Jose, CA (US); Abhijeet Ghadge, San Jose, CA (US); Viraj Suryakant Bhogle, Fremont, CA (US)

(21) Appl. No.: 18/929,293

(22) Filed: Oct. 28, 2024

(51) Int. Cl. G06F 12/0802

(52) U.S. Cl. CPC G06F 12/0802; G06F 2212/60

(57) ABSTRACT

Disclosed are systems and techniques for dynamic L1 cache reconfiguration. The techniques include executing a first task by a processor in a first mode. The processor has a first memory configuration. The techniques further include receiving, at a hardware controller operatively coupled to the processor, a second task with memory metadata. The techniques further include determining a second memory configuration of the processor based on the memory metadata and the first memory configuration of the processor. The techniques further include reconfiguring a memory of the processor based on the second memory configuration. The techniques further include executing the second task by the processor in the first mode.

### TECHNICAL FIELD

At least one embodiment pertains to parallel processing units, and more specifically, to memory configurations of parallel processing units.

### BACKGROUND

Parallel processing units (e.g., graphics processing units (GPUs)) can include specialized electronic circuits designed to rapidly manipulate and alter memory to perform tasks such as matrix multiplication or operations on vectors with high efficiency. Unlike a central processing unit (CPU) that performs sequential processing, a parallel processing unit can be composed of hundreds or even thousands of smaller cores that are optimized for parallel processing.

The architecture of a parallel processing units can make it extremely efficient at processing multiple operations concurrently, particularly those that can be performed in parallel—like mathematical calculations required for 3D graphics rendering. This parallelism can make parallel processing units particularly good not only at graphics rendering but also at computational tasks that can benefit from processing large blocks of data in parallel.

A parallel processing unit can include one or more memories, including a level 1 (L1) cache. The L1 cache memory in a parallel processing unit can be the first level of cache that is directly accessible by each processing unit or core. It can be a small amount of very fast memory located on the parallel processing unit itself, designed to store a subset of data that is frequently accessed or immediately required by the processing core. The presence of L1 cache on a parallel processing unit core can allow for rapid access to critical data, minimizing the delay (e.g., latency) that would result from fetching the data from the main memory (e.g., random access memory (RAM)).

### BRIEF DESCRIPTION OF THE DRAWINGS

FIG. 1 is a block diagram of an example parallel processing unit for dynamic L1 cache reconfiguration, according to at least one embodiment.

FIG. 2 is an example flow diagram for dynamic L1 cache reconfiguration, according to at least one embodiment.

FIG. 3 is an example state diagram for processor timer-based mode switching, according to at least one embodiment.

FIG. 4 is a flow diagram of an example method for dynamic L1 cache reconfiguration, according to at least one embodiment.

FIG. 5A illustrates inference and/or training logic, according to at least one embodiment of the present disclosure.

FIG. 5B illustrates inference and/or training logic, according to at least one embodiment.

FIG. 6 illustrates training and deployment of a neural network, according to at least one embodiment.

FIG. 7 is an example data flow diagram for an advanced computing pipeline, according to at least one embodiment.

FIG. 8 is a system diagram for an example system for training, adapting, instantiating and deploying machine learning models in an advanced computing pipeline, according to at least one embodiment.

### DETAILED DESCRIPTION

A parallel processing unit can be configured to operate in one or more modes. Each mode can include configurations that improve an efficiency of execution of particular types of tasks. For example, a parallel processing unit can have a first mode for executing compute-only tasks (e.g., all-compute mode) and a second mode for executing graphics and/or compute tasks (e.g., compute-in-graphics mode). The parallel processing unit, or one or more components thereof (e.g., main memory components, cache memory components, scheduling components, etc.), may be reconfigured when switching from one mode to another. Switching from one mode to another can cause processing delays (e.g., latency) due to the overhead of reconfiguring the parallel processing unit.

Aspects of the present disclosure address the above and other deficiencies by providing for dynamic L1 cache reconfiguration of a parallel processing unit. A parallel processing unit can be executing in a first mode (e.g., all-compute mode, compute-in-graphics mode). Memory of the parallel processing unit (e.g., L1 cache) can be configured for a currently executing task. For example, the currently executing task may be a compute task and may require a first amount of “tagged” L1 cache memory, leaving the remaining L1 cache memory space as “untagged” memory. In some embodiments, the currently executing task may be a graphics task and may require a first amount of triangle random access memory (TRAM) and a second amount of “tagged” L1 cache memory, leaving the remaining L1 cache memory space as “untagged”memory.

Responsive to a reconfiguration trigger (e.g., receiving a new task for execution), the parallel processing unit can determine whether L1 cache reconfiguration is necessary. The new task may have associated memory metadata including a minimum memory allocation, a target memory allocation, and a maximum memory allocation.

The minimum memory allocation may indicate a minimum amount of memory required for execution of the task. For example, the task may require 10 kilobytes (KB) for a single thread to run. The target memory allocation may indicate a preferred amount of memory for execution of the task. For example, it may be preferred that 5 threads run simultaneously, requiring 50KB of memory. The maximum memory allocation may indicate a maximum amount of memory for execution of the task. For example, it may be preferred that no more than 8 threads run simultaneously, requiring 80 KB of memory as an upper limit. In some embodiments, each allocation can represent the amount of “tagged” L1 memory required for execution of the task. In some embodiments, each allocation can represent the amount of “untagged” L1 memory required for execution of the task. In some embodiments, each allocation can represent the amount of total L1 memory required for execution of the task.

In some embodiments, the memory metadata for a task (e.g., a graphics task) also includes a graphics memory allocation, which can represent the amount of TRAM required for execution of the task. In some embodiments, the graphics memory allocation is 64 KB.

A hardware controller of the parallel processing unit can compare the memory metadata of the task to be executed to the current memory configuration of a processor of the parallel processing unit to determine whether a reconfiguration is necessary before execution of the received task. For example, if the current memory configuration (e.g., current allotment of “tagged” L1 cache memory) is between the minimum memory allocation and the maximum memory allocation of the memory metadata of the received task, the received task can be scheduled for execution immediately without waiting for the processor to idle.

If the current memory configuration (e.g., current allotment of “tagged” L1 cache memory) is not between the minimum memory allocation and the maximum memory allocation of the memory metadata of the received task, the hardware controller can wait for the processor to idle (e.g., to complete all currently executing tasks) before reconfiguring the memory of the processor. Once the processor idles, the memory can be reconfigured based on the target memory allocation of the memory metadata of the received task, and then the received task can be executed using the newly configured memory.

In some embodiments, tasks can have associated priorities and/or come from different queues (e.g., a graphics queue, a data queue, an asynchronous (async) queue, etc.). If multiple tasks are received for execution, the memory metadata of the task with the highest priority can be used during memory reconfiguration.

In some embodiments, to prevent frequent mode switching and its associated latency overhead, a timer can be used to delay mode switching. For example, a processor of the parallel processing unit can be executing in a first mode (e.g., compute-in-graphics mode) after receiving one or more graphics tasks and optionally, one or more compute tasks. The L1 cache can be partitioned into a TRAM portion, a “tagged” portion, and an “untagged” portion. After all graphics tasks have finished execution, regardless of the state of execution of compute tasks, a timer can be started (e.g., the timer can start counting up, the timer can start counting down). If any additional graphics tasks are received, the timer can stop and be reset, and the graphics tasks can be executed. Once the new graphics tasks are finished executing, the timer can be started again. At the expiration of the timer (e.g., once the timer reaches a predetermined target value (e.g., 0, 100, 5000, etc.)), the hardware controller can switch the mode of the processor (e.g., from compute-in-graphics mode to all-compute mode) and perform L1 cache memory reconfiguration.

In some embodiments, a hardware controller can control more than one processor (e.g., 2 processors). If all processors controlled by the hardware controller need memory reconfiguration, deadlocks can occur. To prevent this, the processors controlled by the hardware controller can be drained (e.g., let current executing tasks run to completion so the processor becomes idle) and have their memory reconfigured serially. For example, a hardware controller may control two processors. If both need to have their memory reconfigured, the first processor can be drained while all tasks are executed by the second processor. The first processor's memory can be reconfigured once the first processor is idle. After reconfiguration, the first processor can be used to execute all tasks while the second processor is drained and reconfigured. After the second processor has been reconfigured, both processors can resume executing tasks.

In some embodiments, compute work from multiple tasks can be interleaved during execution on a single processor in an all-compute mode. In some embodiments, compute instruction level preemption (CILP) can be supported in a compute-in-graphics mode.

Advantages of the disclosed embodiments over the existing technology include but are not limited to increased parallel processing unit efficiency, throughput, resource utilization, and improved overall efficiency.

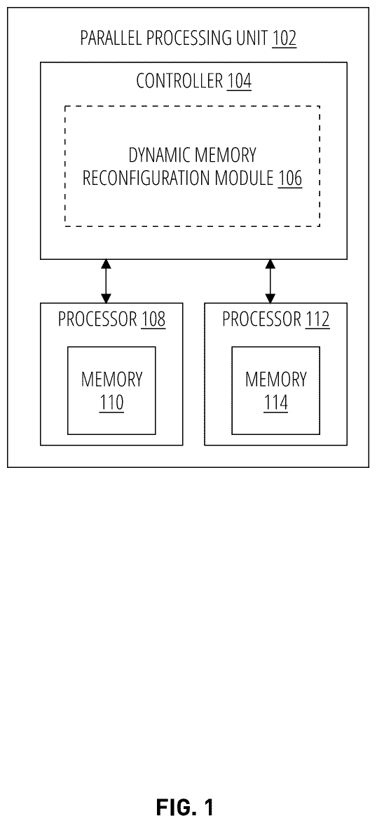

FIG. 1 is a block diagram of an example parallel processing unit 102 for dynamic L1 cache reconfiguration, according to at least one embodiment. In some embodiments, parallel processing unit 102 can be a graphics processing unit (GPU). In some embodiments, parallel processing unit 102 can be included as part of a GPU. Parallel processing unit 102 can be used for tasks that benefit from the execution of many parallel processing threads, such as graphics rendering, machine learning and/or artificial intelligence model training and/or inferencing, and/or the like.

Parallel processing unit 102 can include controller 104 and one or more processors (e.g., processor 108, processor 112, etc.). Controller 104 can be a hardware circuit coupled to processor 108 and/or processor 112. Controller 104 can manage processor 108 and/or processor 112, including providing tasks to processor 108 and/or processor 112 for execution, managing an operating mode (e.g., compute-in-graphics mode, all-compute mode, etc.) of processor 108 and/or processor 112, manage memory configuration of memories of processor 108 and/or processor 112 (e.g., memory 110, memory 114, etc.), and/or the like. In some embodiments, controller 104 can include one or more components of a compute work distributor (CWD) and/or a multi-processor cluster (MPC). In some embodiments, processor 108 and/or processor 112 can be a streaming multiprocessor (SM) of a GPU.

In some embodiments, controller 104 can include dynamic memory reconfiguration module 106 for reconfiguring processor memory. For example, dynamic memory reconfiguration module 106 can reconfigure memory 110 of processor 108 and/or memory 114 of processor 112 based on received tasks that are to be executed by processor 108 and/or processor 112.

Memory 110 and memory 114 can each include a level 1 (L1) cache memory. Each L1 cache memory can be divided into one or more portions. For example, an L1 cache memory can be divided into an “untagged” portion and a “tagged” portion. The “untagged” portion can be used as scratchpad memory and/or shared memory that can be managed by software. The “tagged” portion can have tags associated with the memory addresses of the portion. In some embodiments, an L1 cache memory can have a triangle random access memory (TRAM) portion used for storing triangle data (e.g., vertices, edges, etc.) that can be used during graphics rendering.

Some processes can be performed more efficiently with large amounts of shared memory (e.g., large “untagged” portion), whereas other processes can be performed more efficiently with large amounts of tagged memory (e.g., large “tagged” portion). If no graphics tasks are being executed (e.g., while operating in an all-compute mode), reserving a portion of an L1 cache memory for TRAM can result in wasted resources. Thus, reconfiguring the L1 cache memory based on the process (e.g., task) that is being performed can increase performance of the parallel processing unit.

In some embodiments, processor 108 can be executing in a first mode (e.g., all-compute mode, compute-in-graphics mode, etc.) while processor 112 is executing in a second mode. Memory 110 of processor 108 can be optimally configured for the first mode while memory 114 of processor 112 can be optimally configured for the second mode. In some embodiments, processor 108 and processor 112 can simultaneously execute in the same mode and the respective memories (e.g., memory 110 and memory 114) can have the same (or similar) configuration.

In some embodiments, dynamic memory reconfiguration module 106 can perform one or more steps of method 400 described in more detail below. In some embodiments, controller 104 can perform one or more steps of method 400. In some embodiments, dynamic memory reconfiguration module 106 can be implemented using one or more other components of parallel processing unit 102 and/or controller 104.

Dynamic memory reconfiguration module 106 can reconfigure memory 110 and/or memory 114 based on received tasks that are to be executed by processor 108 and/or processor 112. For example, processor 108 (or processor 112) can be executing a first task, and memory 110 (or memory 114) can be configured for the currently executing task. For example, the currently executing task may be a compute task and may require a first amount of “untagged” L1 cache memory, leaving the remaining L1 cache memory space as “tagged” memory. In some embodiments, the currently executing task may be a graphics task and may require a first amount of graphics-related L1 cache memory (e.g., graphics-related random access memory (RAM)) and a second amount of “untagged” L1 cache memory, leaving the remaining L1 cache memory space as “tagged” memory. In some embodiments, the graphics-related L1 cache memory can be triangle random access memory (TRAM). In some embodiments, the currently executing task can have another memory configuration requirement. For example, the currently executing task may require that the memory (e.g., L1 cache memory) be divided into one or more portions, and each portion may have characteristics different than the other portions. For example, a first portion may be optimized for a first type of data while a second portion is optimized for a second type of data.

Responsive to a reconfiguration trigger (e.g., receiving a new task for execution, changing execution modes (e.g., from all-compute to compute-in-graphics or vice versa), change of priority between compute and graphics tasks, etc.), parallel processing unit 102 can determine whether L1 cache reconfiguration is necessary. The new task can have associated memory metadata indicating a minimum memory allocation, a target memory allocation, and a maximum memory allocation.

The minimum memory allocation may indicate a minimum amount of memory required for execution of the task. For example, the task may require 10 KB for a single thread (e.g., compute thread array (CTA)) to run. The target memory allocation may indicate a preferred amount of memory for execution of the task. For example, it may be preferred that 5 threads run simultaneously, requiring 50 KB of memory. The maximum memory allocation may indicate a maximum amount of memory for execution of the task. For example, it may be preferred that no more than 8 threads run simultaneously, requiring 80 KB of memory as an upper limit. In some embodiments, each allocation can represent the amount of “tagged” L1 memory required for execution of the task. In some embodiments, each allocation can represent the amount of “untagged” L1 memory required for execution of the task. In some embodiments, each allocation can represent the amount of total L1 memory required for execution of the task.

In some embodiments, the memory metadata for a task (e.g., a graphics task) also includes a graphics memory allocation, which can represent the amount of TRAM required for execution of the task. In some embodiments, the graphics memory allocation is 16 KB.

Controller 104 of parallel processing unit 102 (or dynamic memory reconfiguration module 106) can compare the memory metadata of the task to be executed to the current memory configuration of processor 108 to determine whether a reconfiguration is necessary before execution of the received task. For example, if the current memory configuration (e.g., current allotment of “tagged” L1 cache memory, current allotment of “untagged” L1 cache memory, etc.) is between the minimum memory allocation and the maximum memory allocation of the memory metadata of the received task, the received task can be scheduled for execution immediately without reconfiguring the memory, eliminating the latency associated with memory reconfiguration (e.g., waiting for the processor to idle).

If the current memory configuration (e.g., current allotment of “tagged” L1 cache memory, current allotment of “untagged” L1 cache memory, etc.) is not between the minimum memory allocation and the maximum memory allocation of the memory metadata of the received task, the hardware controller can wait for the processor to idle (e.g., to complete all currently executing tasks) before reconfiguring the memory of the processor. Once the processor idles, the memory can be reconfigured based on the target memory allocation of the memory metadata of the received task, and then the received task can be executed using the newly configured memory.

In some embodiments, tasks can have associated priorities and/or come from different queues (e.g., a graphics queue, a data queue, an asynchronous (async) queue, etc.). If multiple tasks are received for execution (e.g., if multiple queues have tasks waiting for execution), the memory metadata of the task with the highest priority can be used during memory reconfiguration.

In some embodiments, controller 104 can control more than one processor (e.g., 2 processors). If all processors controlled by controller 104 have their respective memories reconfigured at the same time, deadlocks can occur. To prevent this, the processors (e.g., processor 108, processor 112) controlled by controller 104 can be drained (e.g., let current executing tasks run to completion so the processor becomes idle) and have their memory reconfigured serially. For example, controller 104 may control two processors: processor 108 and processor 112. If both need to have their memory reconfigured, processor 108 can be drained while all tasks are executed by processor 112. Memory 110 of processor 108 can be reconfigured once processor 108 is idle. After reconfiguration, processor 108 can be used to execute all tasks while processor 112 is drained and memory 114 reconfigured. After memory 114 of processor 112 has been reconfigured, both processors can resume executing tasks.

In some embodiments, compute work from multiple tasks can be interleaved during execution on a single processor (e.g., processor 108) in all-compute mode. For example, controller 104 can launch compute work from two different tasks on the same processor (e.g., on the same streaming multiprocessor (SM)) by interleaving thread (e.g., CTA) launches from the two tasks, enabling simultaneous compute & compute on a single SM (SMSCC). To facilitate SMSCC and to maintain efficient performance, controller 104 can enable resource reservations on the processor (e.g., processor 108) when multiple tasks are being interleaved and can disable resource reservation on the processor (e.g., processor 108) when only a single task is being executed.

In some embodiments, compute instruction level preemption (CILP) can be supported for processors (e.g., SMs) executing in a compute-in-graphics mode. CILP can enable preemption of a first task at instruction boundaries. If a CILP command is received (e.g., by controller 104), the current memory configuration of the processor can be saved and the processor execution mode can change (if necessary) to execute a new task (e.g., a new CTA). When the new task finishes execution, the processor's memory configuration can be restored and the processor can continue execution of the preempted task.

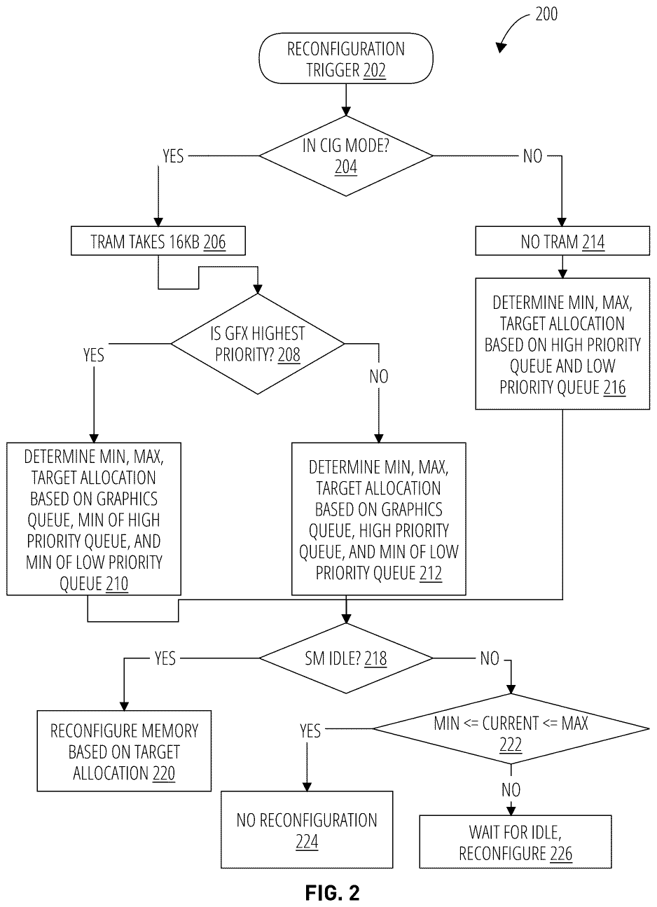

FIG. 2 is an example flow diagram 200 for dynamic L1 cache reconfiguration, according to at least one embodiment. Dynamic L1 cache reconfiguration for the memory of a particular processor can start following an occurrence of reconfiguration trigger 202, which can include receiving a new task for execution, changing execution modes (e.g., from all-compute to compute-in-graphics or vice versa), change of priority between compute and graphics tasks, and the like. At decision block 204 it can be determined (e.g., by controller 104 and/or dynamic memory reconfiguration module 106 of FIG. 1) whether the processor is currently in a compute-in-graphics mode. If the processor is currently in a compute-in-graphics mode, following decision block 204 to the left, at block 206, TRAM can reserve a first portion of the L1 cache, such as 16 KB.

At decision block 208, it can be determined whether graphics tasks have the highest priority. If graphics tasks have the highest priority, following decision block 208 to the left, at block 210, a minimum memory allocation, a maximum memory allocation, and a target memory allocation for the L1 cache can be determined based on the tasks in graphics queue, the tasks in the high priority compute queue, and tasks in the low priority compute queue.

For example, tasks in the graphics queue may always request 64KB of “untagged” L1 cache memory. Memory metadata associated with a task (e.g., the first task, the last task, etc.) in the high priority compute queue can have a minimum amount of memory required to execute a thread (e.g., CTA) of the high priority task. Similarly, memory metadata associated with a task (e.g., the first task, the last task, etc.) in the low priority compute queue can have a minimum amount of memory required to execute a thread (e.g., CTA) of the low priority task. In some embodiments, tasks can be in more than 2 (or 3) queues and the memory metadata of one or more tasks from each queue can be compared in a similar manner. In some embodiments, the high priority compute queue is a data queue and the low priority compute queue is an async queue.

The maximum of each of the minimum memory allocations, maximum memory allocations, and target memory allocations can be determined to obtain a max minimum memory allocation (e.g., max(64 KB for graphics, high priority minimum amount, low priority minimum amount)), a max maximum memory allocation (e.g., max(64 KB for graphics, high priority minimum amount, low priority minimum amount)), and a max target memory allocation (e.g., max(64 KB for graphics, high priority minimum amount, low priority minimum amount)). In some embodiments, the max minimum memory allocation, the max maximum memory allocation, and the max target memory allocation can be the same.

If graphics tasks do not have the highest priority, following decision block 208 to the right, at block 212, a minimum memory allocation, a maximum memory allocation, and a target memory allocation for the L1 cache can be determined based on the tasks in graphics queue, the tasks in the high priority compute queue, and tasks in the low priority compute queue.

For example, tasks in the graphics queue may always request 64 KB of “untagged” L1 cache memory. Memory metadata associated with a task (e.g., the first task, the last task, etc.) in the high priority compute queue can have a minimum memory allocation for the high priority task, a maximum memory allocation for the high priority task, and a target memory allocation for the high priority task. Memory metadata associated with a task (e.g., the first task, the last task, etc.) in the low priority compute queue can have a minimum amount of memory required to execute a thread (e.g., CTA) of the low priority task. In some embodiments, the memory metadata associated with the low priority task can have a minimum memory allocation for the low priority task, a maximum memory allocation for the low priority task, and a target memory allocation for the low priority task.

The maximum of each of the minimum memory allocations, maximum memory allocations, and target memory allocations can be determined to obtain a max minimum memory allocation (e.g., max(64 KB for graphics, high priority minimum, low priority minimum)), a max maximum memory allocation (e.g., max(64 KB for graphics, high priority maximum, low priority minimum)), and a max target memory allocation (e.g., max(64 KB for graphics, high priority target, low priority minimum)).

If the processor is not currently in a compute-in-graphics mode, following decision block 204 to the right, at block 214, no TRAM needs to be reserved, meaning the L1 may include just an “untagged” portion and a “tagged” portion. At block 216, a minimum memory allocation, a maximum memory allocation, and a target memory allocation for the L1 cache can be determined based on the tasks in the high priority compute queue and tasks in the low priority compute queue.

For example, memory metadata associated with a task (e.g., the first task, the last task, etc.) in the high priority compute queue can have a minimum memory allocation for the high priority task, a maximum memory allocation for the high priority task, and a target memory allocation for the high priority task. Memory metadata associated with a task (e.g., the first task, the last task, etc.) in the low priority compute queue can have a minimum amount of memory required to execute a thread (e.g., CTA) of the high priority task.

The maximum of each of the minimum memory allocations, maximum memory allocations, and target memory allocations can be determined to obtain a max minimum memory allocation (e.g., max(high priority minimum, low priority minimum)), a max maximum memory allocation (e.g., max(high priority maximum, low priority minimum)), and a max target memory allocation (e.g., max(high priority target, low priority minimum)).

After determining the max minimum memory allocation, max maximum memory allocation, and max target memory allocation, at decision block 218, it can be determined (e.g., by controller 104) if the relevant SM (e.g., processor, processor 108 of FIG. 1) is idle. If the processor is idle, following decision block 218 to the left, at block 220, the memory of the processor can be reconfigured to have an “untagged” portion equal to the previously determined max target memory allocation. The “tagged” portion of the memory can include the space remaining in the memory after the “untagged”portion has been allocated.

In some embodiments, the “untagged” portion of the memory can include the TRAM portion. For example, if the processor is in a compute-in-graphics mode, the TRAM portion is 16KB, and the determined “untagged” portion is 64 KB (e.g., from the max target memory allocation), the memory can be partitioned into a 16 KB TRAM portion, a 48 KB (e.g., 64 KB-16 KB) portion, and a remaining “tagged” portion.

If the processor (e.g., SM) is not idle, following decision block 218 to the right, at decision block 222, it can be determined (e.g., by controller 104 of FIG. 1) if the current “untagged” portion of the memory of the processor is greater than or equal to the max minimum memory allocation and less than or equal to the max maximum memory allocation. If the current “untagged” portion of the memory is between max minimum memory allocation and max maximum memory allocation, following decision block 222 to the left, at block 224, no reconfiguration needs to be performed and the new task can be executed by the processor. If the current “untagged” portion of the memory is not between max minimum memory allocation and max maximum memory allocation, following decision block 222 down, at block 226, the processor can be drained (e.g., currently executing processes on the processor can finish and no additional work can be scheduled so the processor can reach an idle state), and then the memory of the processor can be reconfigured to have an “untagged” portion equal to the previously determined max target memory allocation.

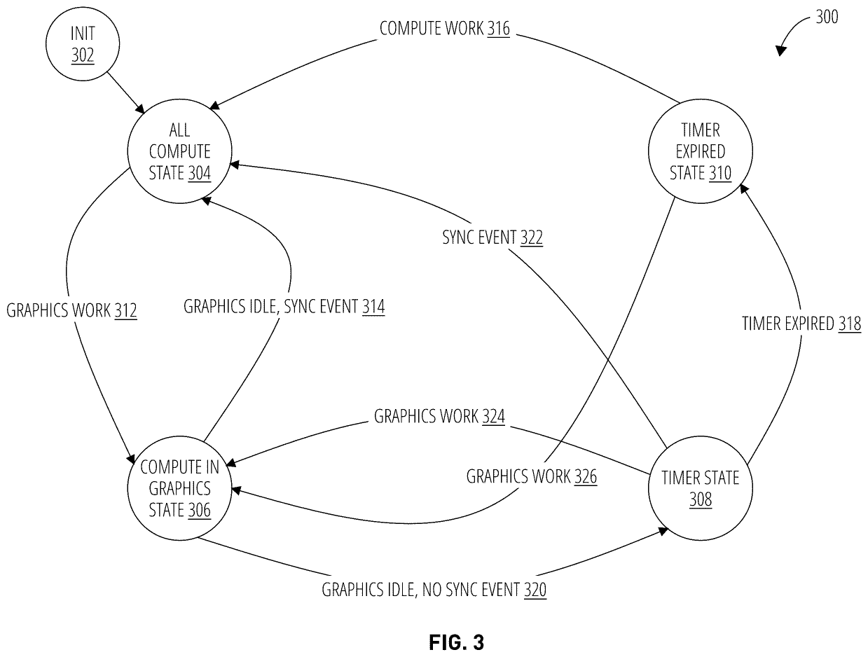

FIG. 3 is an example state diagram 300 for processor timer-based mode switching, according to at least one embodiment. Switching from one mode to another (e.g., from all-compute mode to compute-in-graphics mode, or vice versa) can introduce latency, reducing processor efficiency and throughput. In some embodiments, to prevent frequent mode switching and its associated latency overhead, a timer can be used to delay mode switching. For example, a processor of a parallel processing unit can start (e.g., initialize (“init”) 302) in an initial state: all compute state 304. The processor can transition 312 to compute in graphics state 306 after receiving graphics work (e.g., one or more graphics tasks) and optionally, one or more compute tasks. The memory of the processor (e.g., L1 cache) can be partitioned into a TRAM portion, a “tagged” portion, and an “untagged” portion, as described above. After all graphics tasks have finished execution, regardless of the state of execution of compute tasks, if no synchronization event has been received, the processor can transition 320 to timer state 308, and a timer can be started (e.g., the timer can start counting up, the timer can start counting down). If any additional graphics tasks are received, the processor can transition 324 to compute in graphics state 306, the timer can stop and be reset, and the graphics tasks can be executed. Once the new graphics tasks are finished executing, the processor can transition 320 back to timer state 308, and the timer can be started again. If the processor is in compute in graphics state 306, all graphics tasks have finished execution, and a synchronization event is received, the processor can transition 314 back to all compute state 304.

While in timer state 308, if the processor receives a synchronization event, the processor can transition 322 to all compute state 304. At the expiration of the timer (e.g., once the timer reaches a predetermined target value (e.g., 0, 100, 5000, etc.)), the processor can transition 318 to timer expired state 310. If additional compute tasks are received while in timer expired state 310, the processor can transition 316 to all compute state 304. If additional graphics tasks are received while in timer expired state 310, the processor can transition 326 to compute in graphics state 306.

In some embodiments, the state of the processor is controlled by a communicatively coupled hardware controller (e.g., controller 104 of FIG. 1). In some embodiments, L1 cache memory reconfiguration can occur when transitioning to all compute state 304 from compute in graphics state 306, timer state 308, or timer expired state 310. In some embodiments, L1 cache memory reconfiguration can occur when transitioning to compute in graphics state 306 from all compute state 304.

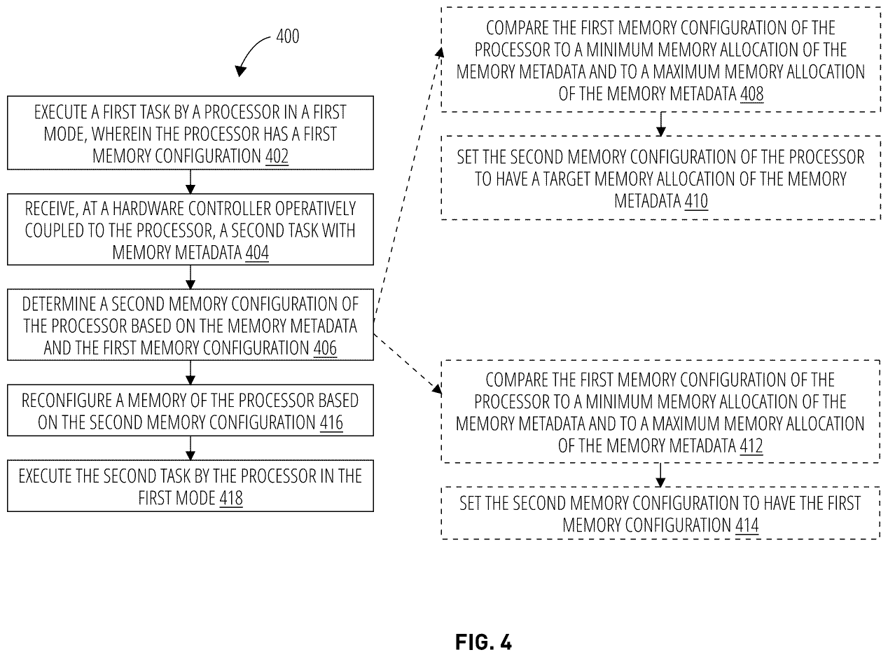

FIG. 4 is a flow diagram of an example method 400 for dynamic L1 cache reconfiguration, according to at least one embodiment. Method 400 can be performed using one or more processing units (e.g., CPUs, GPUs, accelerators, physics processing units (PPUs), data processing units (DPUs), etc.), which may include (or communicate with) one or more memory devices. In at least one embodiment, method 400 can be performed using a processing device or processing devices. In at least one embodiment, method 400 can be performed using processing units of parallel processing unit 102 of FIG. 1. In at least one embodiment, processing units performing method 400 can be executing instructions stored on a non-transient computer readable storage media. In at least one embodiment, method 400 can be performed using multiple processing threads (e.g., CPU threads and/or GPU threads), individual threads executing one or more individual functions, routines, subroutines, or operations of the method. In at least one embodiment, processing threads implementing method 400 can be synchronized (e.g., using semaphores, critical sections, and/or other thread synchronization mechanisms).

Alternatively, processing threads implementing method 400 can be executed asynchronously with respect to each other. Various operations of method 400 can be performed in a different order compared with the order shown in FIG. 4. Some operations of method 400 can be performed concurrently with other operations. In at least one embodiment, one or more operations shown in FIG. 4 may not always be performed.

Referring to FIG. 4, at block 402, processing units executing method 400 can execute a first task by a processor in a first mode. The processor can have a first memory configuration. At block 404, processing units can receive, at a hardware controller operatively coupled to the processor, a second task with memory metadata. At block 406, processing units can determine a second memory configuration of the processor based on the memory metadata and the first memory configuration.

In some embodiments, to determine the second memory configuration of the processor based on the memory metadata and the first memory configuration, at block 408, processing units can compare the first memory configuration of the processor to a minimum memory allocation of the memory metadata and to a maximum memory allocation of the memory metadata. At block 410, processing units can, responsive to the first memory configuration of the processor being outside of the minimum memory allocation of the memory metadata and outside of the maximum memory allocation of the memory metadata (e.g., outside of the range starting with the minimum memory allocation of the memory metadata and ending with the maximum memory allocation of the memory metadata), set the second memory configuration of the processor to have the target memory allocation. For example, the second memory configuration can include the target memory allocation of the memory metadata. In some embodiments, the target memory allocation indicates an allocation for the “untagged” portion of the memory. Allocations for the “tagged” and/or TRAM portions of the memory can be determined based on the allocation of the “untagged”portion.

In some embodiments, to determine the second memory configuration of the processor based on the memory metadata and the first memory configuration, at block 412, processing units can compare the first memory configuration of the processor to a minimum memory allocation of the memory metadata and to a maximum memory allocation of the memory metadata. At block 414, processing units can, responsive to the first memory configuration of the processor being between the minimum memory allocation of the memory metadata and the maximum memory allocation of the memory metadata (e.g., being within the range starting with the minimum memory allocation of the memory metadata and ending with the maximum memory allocation of the memory metadata), set the second memory configuration to have the first memory configuration. For example, the second memory configuration can include the same memory configuration as the first memory configuration.

In some embodiments, a memory configuration can include an “untagged” memory allocation, a “tagged” memory allocation, and/or a TRAM memory allocation. In some embodiments, when comparing a first memory configuration to a second memory configuration, a first allocation of the first memory configuration can be compared to a corresponding allocation of the second memory configuration. In some embodiments, when comparing a first memory configuration to a second memory configuration, all allocations of the first memory configuration can be compared to corresponding allocations of the second memory configuration.

At block 416, processing units executing method 400 can reconfigure a memory of the processor based on the second memory configuration. In some embodiments, the memory reconfiguration can be responsive to a reconfiguration trigger.

At block 418, processing units can execute the second task by the processor in the first mode. For example, the processor can be executing in a compute-in-graphics mode, can receive a new task, can reconfigure the processor memory, and can execute the new task while remaining in the compute-in-graphics mode.

In some embodiments, while executing in an all-compute mode, a memory configuration can include a “tagged” L1 cache portion and an “untagged” L1 cache portion. In some embodiments, while executing in a compute-in-graphics mode, a memory configuration can include a “tagged” L1 cache portion, an “untagged” L1 cache portion, and a TRAM L1 cache portion.

### INFERENCE AND TRAINING LOGIC

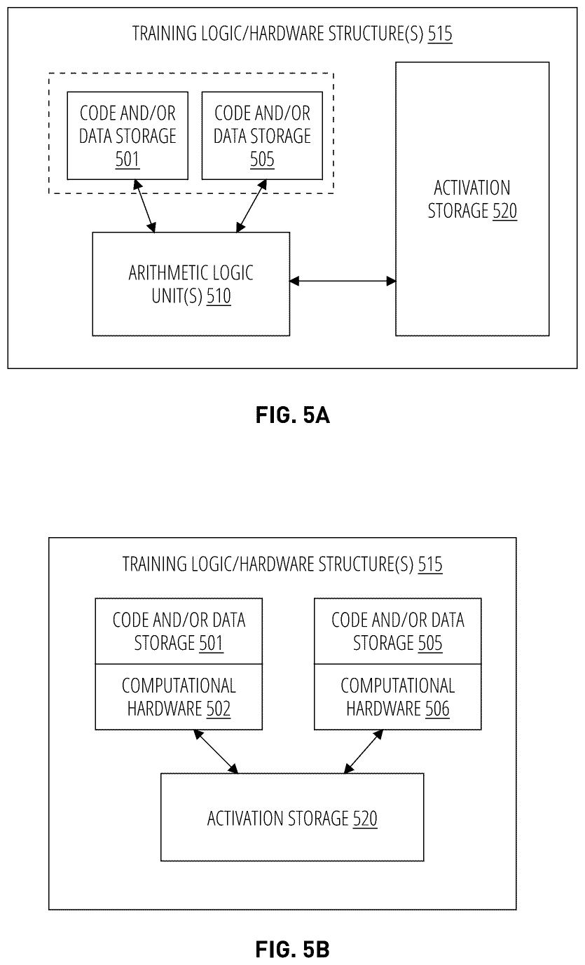

FIG. 5A illustrates inference and/or training logic 515 used to perform inferencing and/or training operations associated with one or more embodiments.

In at least one embodiment, inference and/or training logic 515 may include, without limitation, code and/or data storage 501 to store forward and/or output weight and/or input/output data, and/or other parameters to configure neurons or layers of a neural network trained and/or used for inferencing in aspects of one or more embodiments. In at least one embodiment, training logic 515 may include (or be coupled to code and/or data storage 501 that stores) graph code or other software to control timing and/or order, in which weight and/or other parameter information is to be loaded to configure processing units, including logic units, integer and/or floating point units (collectively, arithmetic logic units (ALUs) or simply circuits). In at least one embodiment, code, such as graph code, loads weight or other parameter information into processor ALUs based on an architecture of a neural network to which such code corresponds. In at least one embodiment, code and/or data storage 501 stores weight parameters and/or input/output data of each layer of a neural network trained or used in conjunction with one or more embodiments during forward propagation of input/output data and/or weight parameters during training and/or inferencing using aspects of one or more embodiments. In at least one embodiment, any portion of code and/or data storage 501 may be included with other on-chip or off-chip data storage, including a processor's L1, L2, or L3 cache or system memory.

In at least one embodiment, any portion of code and/or data storage 501 may be internal or external to one or more processors or other hardware logic devices or circuits. In at least one embodiment, code and/or data storage 501 may be cache memory, dynamic randomly addressable memory (“DRAM”), static randomly addressable memory (“SRAM”), non-volatile memory (e.g., flash memory), or other storage. In at least one embodiment, a choice of whether code and/or data storage 501 is internal or external to a processor, for example, or comprising DRAM, SRAM, flash or some other storage type may depend on available storage on-chip versus off-chip, latency requirements of training and/or inferencing functions being performed, batch size of data used in inferencing and/or training of a neural network, or some combination of these factors.

In at least one embodiment, inference and/or training logic 515 may include, without limitation, a code and/or data storage 505 to store backward and/or output weight and/or input/output data corresponding to neurons or layers of a neural network trained and/or used for inferencing in aspects of one or more embodiments. In at least one embodiment, code and/or data storage 505 stores weight parameters and/or input/output data of each layer of a neural network trained or used in conjunction with one or more embodiments during backward propagation of input/output data and/or weight parameters during training and/or inferencing using aspects of one or more embodiments. In at least one embodiment, training logic 515 may include (or be coupled to code and/or data storage 505 that stores) graph code or other software to control timing and/or order, in which weight and/or other parameter information is to be loaded to configure processing units, including logic units, integer and/or floating point units (collectively, arithmetic logic units (ALUs)).

In at least one embodiment, code, such as graph code, causes the loading of weight or other parameter information into processor ALUs based on an architecture of a neural network to which such code corresponds. In at least one embodiment, any portion of code and/or data storage 505 may be included with other on-chip or off-chip data storage, including a processor's L1, L2, or L3 cache or system memory. In at least one embodiment, any portion of code and/or data storage 505 may be internal or external to one or more processors or other hardware logic devices or circuits. In at least one embodiment, code and/or data storage 505 may be cache memory, DRAM, SRAM, non-volatile memory (e.g., flash memory), or other storage. In at least one embodiment, a choice of whether code and/or data storage 505 is internal or external to a processor, for example, or comprising DRAM, SRAM, flash memory or some other storage type may depend on available storage on-chip versus off-chip, latency requirements of training and/or inferencing functions being performed, batch size of data used in inferencing and/or training of a neural network, or some combination of these factors.

In at least one embodiment, code and/or code and/or data storage 501 and code and/or data storage 505 may be separate storage structures. In at least one embodiment, code and/or data storage 501 and code and/or data storage 505 may be a combined storage structure. In at least one embodiment, code and/or data storage 501 and code and/or data storage 505 may be partially combined and partially separate. In at least one embodiment, any portion of code and/or data storage 501 and code and/or data storage 505 may be included with other on-chip or off-chip data storage, including a processor's L1, L2, or L3 cache or system memory.

In at least one embodiment, inference and/or training logic 515 may include, without limitation, one or more arithmetic logic unit(s) (“ALU(s)”) 510, including integer and/or floating point units, to perform logical and/or mathematical operations based, at least in part on, or indicated by, training and/or inference code (e.g., graph code), a result of which may produce activations (e.g., output values from layers or neurons within a neural network) stored in an activation storage 520 that are functions of input/output and/or weight parameter data stored in code and/or data storage 501 and/or code and/or data storage 505. In at least one embodiment, activations stored in activation storage 520 are generated according to linear algebraic and/or matrix-based mathematics performed by ALU(s) 510 in response to performing instructions or other code, wherein weight values stored in code and/or data storage 505 and/or code and/or data storage 501 are used as operands along with other values, such as bias values, gradient information, momentum values, or other parameters or hyperparameters, any or all of which may be stored in code and/or data storage 505 or code and/or code and/or data storage 501 or another storage on or off-chip.

In at least one embodiment, ALU(s) 510 are included within one or more processors or other hardware logic devices or circuits, whereas in another embodiment, ALU(s) 510 may be external to a processor or other hardware logic device or circuit that uses them (e.g., a co-processor). In at least one embodiment, ALU(s) 510 may be included within a processor's execution units or otherwise within a bank of ALUs accessible by a processor's execution units either within the same processor or distributed between different processors of different types (e.g., central processing units, graphics processing units, fixed function units, etc.). In at least one embodiment, code and/or data storage 501, code and/or data storage 505, and activation storage 520 may share a processor or other hardware logic device or circuit, whereas in another embodiment, they may be in different processors or other hardware logic devices or circuits, or some combination of same and different processors or other hardware logic devices or circuits. In at least one embodiment, any portion of activation storage 520 may be included with other on-chip or off-chip data storage, including a processor's L1, L2, or L3 cache or system memory. Furthermore, inferencing and/or training code may be stored with other code accessible to a processor or other hardware logic or circuit and fetched and/or processed using a processor's fetch, decode, scheduling, execution, retirement and/or other logical circuits.

In at least one embodiment, activation storage 520 may be cache memory, DRAM, SRAM, non-volatile memory (e.g., flash memory), or other storage. In at least one embodiment, activation storage 520 may be completely or partially within or external to one or more processors or other logical circuits. In at least one embodiment, a choice of whether activation storage 520 is internal or external to a processor, for example, or comprising DRAM, SRAM, flash memory or some other storage type may depend on available storage on-chip versus off-chip, latency requirements of training and/or inferencing functions being performed, batch size of data used in inferencing and/or training of a neural network, or some combination of these factors.

In at least one embodiment, inference and/or training logic 515 illustrated in FIG. 5A may be used in conjunction with an application-specific integrated circuit (“ASIC”), such as a TensorFlow® Processing Unit from Google, an inference processing unit (IPU) from Graphcore™, or a Nervana® (e.g., “Lake Crest”) processor from Intel Corp. In at least one embodiment, inference and/or training logic 515 illustrated in FIG. 5A may be used in conjunction with central processing unit (“CPU”) hardware, graphics processing unit (“GPU”) hardware or other hardware, such as field programmable gate arrays (“FPGAs”).

FIG. 5B illustrates inference and/or training logic 515, according to at least one embodiment. In at least one embodiment, inference and/or training logic 515 may include, without limitation, hardware logic in which computational resources are dedicated or otherwise exclusively used in conjunction with weight values or other information corresponding to one or more layers of neurons within a neural network. In at least one embodiment, inference and/or training logic 515 illustrated in FIG. 5B may be used in conjunction with an application-specific integrated circuit (ASIC), such as TensorFlow® Processing Unit from Google, an inference processing unit (IPU) from Graphcore™, or a Nervana® (e.g., “Lake Crest”) processor from Intel Corp. In at least one embodiment, inference and/or training logic 515 illustrated in FIG. 5B may be used in conjunction with central processing unit (CPU) hardware, graphics processing unit (GPU) hardware or other hardware, such as field programmable gate arrays (FPGAs). In at least one embodiment, inference and/or training logic 515 includes, without limitation, code and/or data storage 501 and code and/or data storage 505, which may be used to store code (e.g., graph code), weight values and/or other information, including bias values, gradient information, momentum values, and/or other parameter or hyperparameter information. In at least one embodiment illustrated in FIG. 5B, each of code and/or data storage 501 and code and/or data storage 505 is associated with a dedicated computational resource, such as computational hardware 502 and computational hardware 506, respectively. In at least one embodiment, each of computational hardware 502 and computational hardware 506 comprises one or more ALUs that perform mathematical functions, such as linear algebraic functions, only on information stored in code and/or data storage 501 and code and/or data storage 505, respectively, the result of which is stored in activation storage 520.

In at least one embodiment, each of code and/or data storage 501 and 505 and corresponding computational hardware 502 and 506, respectively, correspond to different layers of a neural network, such that resulting activation from one storage/computational pair 501/502 of code and/or data storage 501 and computational hardware 502 is provided as an input to a next storage/computational pair 505/506 of code and/or data storage 505 and computational hardware 506, in order to mirror a conceptual organization of a neural network. In at least one embodiment, each of storage/computational pairs 501/502 and 505/506 may correspond to more than one neural network layer. In at least one embodiment, additional storage/computation pairs (not shown) subsequent to or in parallel with storage/computation pairs 501/502 and 505/506 may be included in inference and/or training logic 515.

### NEURAL NETWORK TRAINING AND DEPLOYMENT

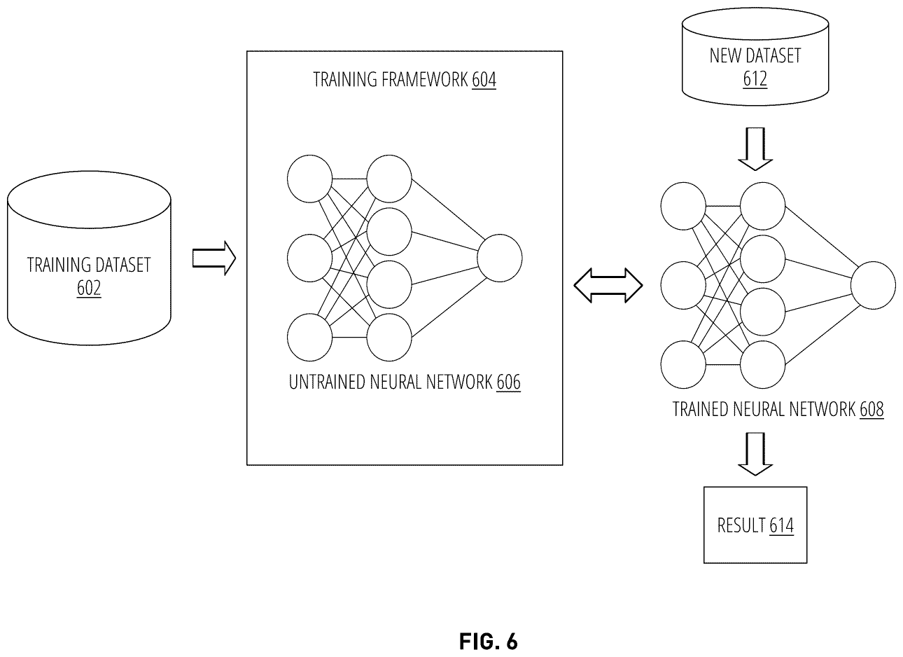

FIG. 6 illustrates training and deployment of a deep neural network, according to at least one embodiment. In at least one embodiment, untrained neural network 606 is trained using a training dataset 602. In at least one embodiment, training framework 604 is a PyTorch framework, whereas in other embodiments, training framework 604 is a TensorFlow, Boost, Caffe, Microsoft Cognitive Toolkit/CNTK, MXNet, Chainer, Keras, Deeplearning4j, or other training framework. In at least one embodiment, training framework 604 trains an untrained neural network 606 and enables it to be trained using processing resources described herein to generate a trained neural network 608. In at least one embodiment, weights may be chosen randomly or by pre-training using a deep belief network. In at least one embodiment, training may be performed in either a supervised, partially supervised, or unsupervised manner.

In at least one embodiment, untrained neural network 606 is trained using supervised learning, wherein training dataset 602 includes an input paired with a desired output for an input, or where training dataset 602 includes input having a known output and an output of neural network 606 is manually graded. In at least one embodiment, untrained neural network 606 is trained in a supervised manner and processes inputs from training dataset 602 and compares resulting outputs against a set of expected or desired outputs. In at least one embodiment, errors are then propagated back through untrained neural network 606. In at least one embodiment, training framework 604 adjusts weights that control untrained neural network 606. In at least one embodiment, training framework 604 includes tools to monitor how well untrained neural network 606 is converging towards a model, such as trained neural network 608, suitable to generating correct answers, such as in result 614, based on input data such as a new dataset 612. In at least one embodiment, training framework 604 trains untrained neural network 606 repeatedly while adjusting weights to refine an output of untrained neural network 606 using a loss function and adjustment algorithm, such as stochastic gradient descent. In at least one embodiment, training framework 604 trains untrained neural network 606 until untrained neural network 606 achieves a desired accuracy. In at least one embodiment, trained neural network 608 can then be deployed to implement any number of machine learning operations.

In at least one embodiment, untrained neural network 606 is trained using unsupervised learning, wherein untrained neural network 606 attempts to train itself using unlabeled data. In at least one embodiment, unsupervised learning training dataset 602 will include input data without any associated output data or “ground truth” data. In at least one embodiment, untrained neural network 606 can learn groupings within training dataset 602 and can determine how individual inputs are related to untrained dataset 602. In at least one embodiment, unsupervised training can be used to generate a self-organizing map in trained neural network 608 capable of performing operations useful in reducing dimensionality of new dataset 612. In at least one embodiment, unsupervised training can also be used to perform anomaly detection, which allows identification of data points in new dataset 612 that deviate from normal patterns of new dataset 612.

In at least one embodiment, semi-supervised learning may be used, which is a technique in which training dataset 602 includes a mix of labeled and unlabeled data. In at least one embodiment, training framework 604 may be used to perform incremental learning, such as through transferred learning techniques. In at least one embodiment, incremental learning enables trained neural network 608 to adapt to new dataset 612 without forgetting knowledge instilled within trained neural network 608 during initial training.

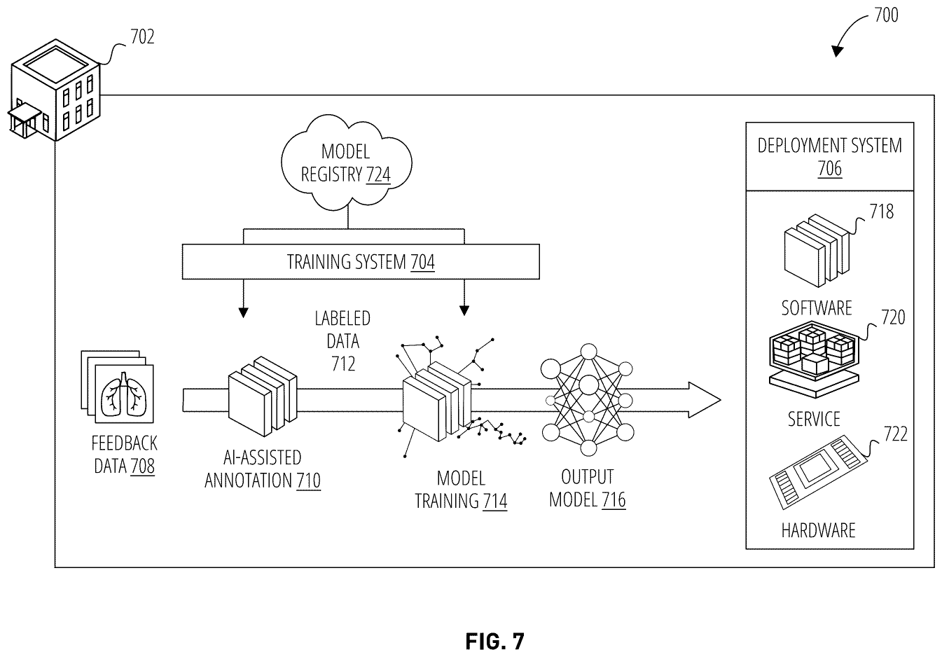

With reference to FIG. 7, FIG. 7 is an example data flow diagram for a process 700 of generating and deploying a processing and inferencing pipeline, according to at least one embodiment. In at least one embodiment, process 700 may be deployed to perform game name recognition analysis and inferencing on user feedback data at one or more facilities 702, such as a data center.

In at least one embodiment, process 700 may be executed within a training system 704 and/or a deployment system 706. In at least one embodiment, training system 704 may be used to perform training, deployment, and embodiment of machine learning models (e.g., neural networks, object detection algorithms, computer vision algorithms, etc.) for use in deployment system 706. In at least one embodiment, deployment system 706 may be configured to offload processing and compute resources among a distributed computing environment to reduce infrastructure requirements at facility 702. In at least one embodiment, deployment system 706 may provide a streamlined platform for selecting, customizing, and implementing virtual instruments for use with computing devices at facility 702. In at least one embodiment, virtual instruments may include software-defined applications for performing one or more processing operations with respect to feedback data. In at least one embodiment, one or more applications in a pipeline may use or call upon services (e.g., inference, visualization, compute, AI, etc.) of deployment system 706 during execution of applications.

In at least one embodiment, some applications used in advanced processing and inferencing pipelines may use machine learning models or other AI to perform one or more processing steps. In at least one embodiment, machine learning models may be trained at facility 702 using feedback data 708 (such as imaging data) stored at facility 702 or feedback data 708 from another facility or facilities, or a combination thereof. In at least one embodiment, training system 704 may be used to provide applications, services, and/or other resources for generating working, deployable machine learning models for deployment system 706.

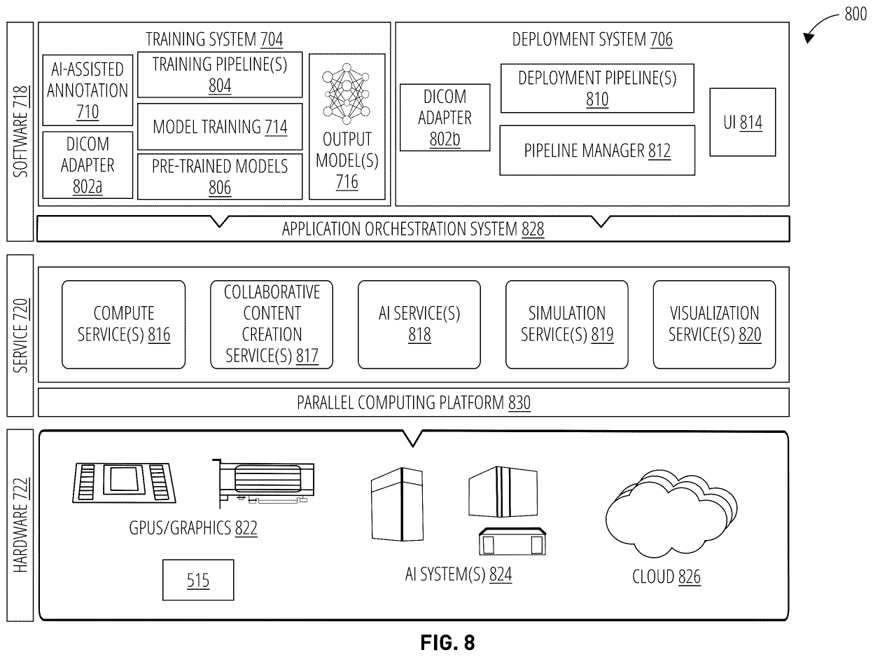

In at least one embodiment, a model registry 724 may be backed by object storage that may support versioning and object metadata. In at least one embodiment, object storage may be accessible through, for example, a cloud storage (e.g., a cloud 826 of FIG. 8) compatible application programming interface (API) from within a cloud platform. In at least one embodiment, machine learning models within model registry 724 may be uploaded, listed, modified, or deleted by developers or partners of a system interacting with an API. In at least one embodiment, an API may provide access to methods that allow users with appropriate credentials to associate models with applications, such that models may be executed as part of execution of containerized instantiations of applications.

In at least one embodiment, a training pipeline(s) 804 (FIG. 8) may include a scenario where facility 702 is training their own machine learning model or has an existing machine learning model that needs to be optimized or updated. In at least one embodiment, feedback data 708 may be received from various channels, such as forums, web forms, or the like. In at least one embodiment, once feedback data 708 is received, AI-assisted annotation 710 may be used to aid in generating annotations corresponding to feedback data 708 to be used as ground truth data for a machine learning model. In at least one embodiment, AI-assisted annotation 710 may include one or more machine learning models (e.g., convolutional neural networks (CNNs)) that may be trained to generate annotations corresponding to certain types of feedback data 708 (e.g., from certain devices) and/or certain types of anomalies in feedback data 708. In at least one embodiment, AI-assisted annotations 710 may then be used directly, or may be adjusted or fine-tuned using an annotation tool, to generate ground truth data. In at least one embodiment, in some examples, labeled data 712 may be used as ground truth data for training a machine learning model. In at least one embodiment, AI-assisted annotations 710, labeled data 712, or a combination thereof may be used as ground truth data for training a machine learning model, e.g., via model training 714 in FIG. 7 and/or FIG. 8. In at least one embodiment, a trained machine learning model may be referred to as an output model 716, and may be used by deployment system 706, as described herein.

In at least one embodiment, training pipeline(s) 804 (FIG. 8) may include a scenario where facility 702 needs a machine learning model for use in performing one or more processing tasks for one or more applications in deployment system 706, but facility 702 may not currently have such a machine learning model (or may not have a model that is optimized, efficient, or effective for such purposes). In at least one embodiment, an existing machine learning model may be selected from model registry 724. In at least one embodiment, model registry 724 may include machine learning models trained to perform a variety of different inference tasks on imaging data. In at least one embodiment, machine learning models in model registry 724 may have been trained on imaging data from different facilities than facility 702 (e.g., facilities that are remotely located). In at least one embodiment, machine learning models may have been trained on imaging data from one location, two locations, or any number of locations. In at least one embodiment, when being trained on imaging data, which may be a form of feedback data 708, from a specific location, training may take place at that location, or at least in a manner that protects confidentiality of imaging data or restricts imaging data from being transferred off-premises (e.g., to comply with HIPAA regulations, privacy regulations, etc.). In at least one embodiment, once a model is trained—or partially trained—at one location, a machine learning model may be added to model registry 724. In at least one embodiment, a machine learning model may then be retrained, or updated, at any number of other facilities, and a retrained or updated model may be made available in model registry 724. In at least one embodiment, a machine learning model may then be selected from model registry 724—and referred to as output model(s) 716—and may be used in deployment system 706 to perform one or more processing tasks for one or more applications of a deployment system.

In at least one embodiment, training pipeline(s) 804 (FIG. 8) may be used in a scenario that includes facility 702 requiring a machine learning model for use in performing one or more processing tasks for one or more applications in deployment system 706, but facility 702 may not currently have such a machine learning model (or may not have a model that is optimized, efficient, or effective for such purposes). In at least one embodiment, a machine learning model selected from model registry 724 might not be fine-tuned or optimized for feedback data 708 generated at facility 702 because of differences in populations, genetic variations, robustness of training data used to train a machine learning model, diversity in anomalies of training data, and/or other issues with training data. In at least one embodiment, AI-assisted annotation 710 may be used to aid in generating annotations corresponding to feedback data 708 to be used as ground truth data for retraining or updating a machine learning model. In at least one embodiment, labeled data 712 may be used as ground truth data for training a machine learning model. In at least one embodiment, retraining or updating a machine learning model may be referred to as model training 714. In at least one embodiment, model training 714 may include data—e.g., AI-assisted annotations 710, labeled data 712, or a combination thereof—that may be used as ground truth data for retraining or updating a machine learning model.

In at least one embodiment, deployment system 706 may include software 718, service 720, hardware 722, and/or other components, features, and functionality. In at least one embodiment, deployment system 706 may include a software “stack,” such that software 718 may be built on top of service 720 and may use service 720 to perform some or all of processing tasks, and service 720 and software 718 may be built on top of hardware 722 and use hardware 722 to execute processing, storage, and/or other compute tasks of deployment system 706.

In at least one embodiment, software 718 may include any number of different containers, where each container may execute an instantiation of an application. In at least one embodiment, each application may perform one or more processing tasks in an advanced processing and inferencing pipeline (e.g., inferencing, object detection, feature detection, segmentation, image enhancement, calibration, etc.). In at least one embodiment, for each type of computing device there may be any number of containers that may perform a data processing task with respect to feedback data 708 (or other data types, such as those described herein). In at least one embodiment, an advanced processing and inferencing pipeline may be defined based on selections of different containers that are desired or required for processing feedback data 708, in addition to containers that receive and configure imaging data for use by each container and/or for use by facility 702 after processing through a pipeline (e.g., to convert outputs back to a usable data type for storage and display at facility 702). In at least one embodiment, a combination of containers within software 718 (e.g., that make up a pipeline) may be referred to as a virtual instrument (as described in more detail herein), and a virtual instrument may leverage service 720 and hardware 722 to execute some or all processing tasks of applications instantiated in containers.

In at least one embodiment, data may undergo pre-processing as part of data processing pipeline to prepare data for processing by one or more applications. In at least one embodiment, post-processing may be performed on an output of one or more inferencing tasks or other processing tasks of a pipeline to prepare an output data for a next application and/or to prepare output data for transmission and/or use by a user (e.g., as a response to an inference request). In at least one embodiment, inferencing tasks may be performed by one or more machine learning models, such as trained or deployed neural networks, which may include output model(s) 716 of training system 704.

In at least one embodiment, tasks of data processing pipeline may be encapsulated in one or more container(s) that each represent a discrete, fully functional instantiation of an application and virtualized computing environment that is able to reference machine learning models. In at least one embodiment, containers or applications may be published into a private (e.g., limited access) area of a container registry (described in more detail herein), and trained or deployed models may be stored in model registry 724 and associated with one or more applications. In at least one embodiment, images of applications (e.g., container images) may be available in a container registry, and once selected by a user from a container registry for deployment in a pipeline, an image may be used to generate a container for an instantiation of an application for use by a user system.

In at least one embodiment, developers may develop, publish, and store applications (e.g., as containers) for performing processing and/or inferencing on supplied data. In at least one embodiment, development, publishing, and/or storing may be performed using a software development kit (SDK) associated with a system (e.g., to ensure that an application and/or container developed is compliant with or compatible with a system). In at least one embodiment, an application that is developed may be tested locally (e.g., at a first facility, on data from a first facility) with an SDK which may support at least some of services 720 as a system (e.g., system 800 of FIG. 8). In at least one embodiment, once validated by system 800 (e.g., for accuracy, etc.), an application may be available in a container registry for selection and/or embodiment by a user (e.g., a hospital, clinic, lab, healthcare provider, etc.) to perform one or more processing tasks with respect to data at a facility (e.g., a second facility) of a user.

In at least one embodiment, developers may then share applications or containers through a network for access and use by users of a system (e.g., system 800 of FIG. 8). In at least one embodiment, completed and validated applications or containers may be stored in a container registry and associated machine learning models may be stored in model registry 724. In at least one embodiment, a requesting entity that provides an inference or image processing request may browse a container registry and/or model registry 724 for an application, container, dataset, machine learning model, etc., select a desired combination of elements for inclusion in data processing pipeline, and submit a processing request. In at least one embodiment, a request may include input data that is necessary to perform a request, and/or may include a selection of application(s) and/or machine learning models to be executed in processing a request. In at least one embodiment, a request may then be passed to one or more components of deployment system 706 (e.g., a cloud) to perform processing of a data processing pipeline. In at least one embodiment, processing by deployment system 706 may include referencing selected elements (e.g., applications, containers, models, etc.) from a container registry and/or model registry 724. In at least one embodiment, once results are generated by a pipeline, results may be returned to a user for reference (e.g., for viewing in a viewing application suite executing on a local, on-premises workstation or terminal).

In at least one embodiment, to aid in processing or execution of applications or containers in pipelines, service 720 may be leveraged. In at least one embodiment, service 720 may include compute services, collaborative content creation services, simulation services, artificial intelligence (AI) services, visualization services, and/or other service types. In at least one embodiment, service 720 may provide functionality that is common to one or more applications in software 718, so functionality may be abstracted to a service that may be called upon or leveraged by applications. In at least one embodiment, functionality provided by service 720 may run dynamically and more efficiently, while also scaling well by allowing applications to process data in parallel, e.g., using a parallel computing platform 830 (FIG. 8). In at least one embodiment, rather than each application that shares a same functionality offered by a service 720 being required to have a respective instance of service 720, service 720 may be shared between and among various applications. In at least one embodiment, services may include an inference server or engine that may be used for executing detection or segmentation tasks, as non-limiting examples. In at least one embodiment, a model training service may be included that may provide machine learning model training and/or retraining capabilities.

In at least one embodiment, where a service 720 includes an AI service (e.g., an inference service), one or more machine learning models associated with an application for anomaly detection (e.g., tumors, growth abnormalities, scarring, etc.) may be executed by calling upon (e.g., as an API call) an inference service (e.g., an inference server) to execute machine learning model(s), or processing thereof, as part of application execution. In at least one embodiment, where another application includes one or more machine learning models for segmentation tasks, an application may call upon an inference service to execute machine learning models for performing one or more processing operations associated with segmentation tasks. In at least one embodiment, software 718 implementing advanced processing and inferencing pipeline may be streamlined because each application may call upon the same inference service to perform one or more inferencing tasks.

In at least one embodiment, hardware 722 may include GPUs, CPUs, data processing units (DPUs), an AI/deep learning system (e.g., an AI supercomputer, such as NVIDIA's DGX™ supercomputer system), a cloud platform, or a combination thereof. In at least one embodiment, different types of hardware 722 may be used to provide efficient, purpose-built support for software 718 and service 720 in deployment system 706. In at least one embodiment, use of GPU processing may be implemented for processing locally (e.g., at facility 702), within an AI/deep learning system, in a cloud system, and/or in other processing components of deployment system 706 to improve efficiency, accuracy, and efficacy of game name recognition.

In at least one embodiment, software 718 and/or service 720 may be optimized for GPU processing with respect to deep learning, machine learning, and/or high-performance computing, simulation, and visual computing, as non-limiting examples. In at least one embodiment, at least some of the computing environment of deployment system 706 and/or training system 704 may be executed in a datacenter or one or more supercomputers or high performance computing systems, with GPU-optimized software (e.g., hardware and software combination of NVIDIA's DGX™ system). In at least one embodiment, hardware 722 may include any number of GPUs that may be called upon to perform processing of data in parallel, as described herein. In at least one embodiment, cloud platform may further include GPU processing for GPU-optimized execution of deep learning tasks, machine learning tasks, or other computing tasks. In at least one embodiment, cloud platform (e.g., NVIDIA's NGC™) may be executed using an AI/deep learning supercomputer(s) and/or GPU-optimized software (e.g., as provided on NVIDIA's DGX™ systems) as a hardware abstraction and scaling platform. In at least one embodiment, cloud platform may integrate an application container clustering system or orchestration system (e.g., KUBERNETES) on multiple GPUs to enable seamless scaling and load balancing.

FIG. 8 is a system diagram for an example system 800 for generating and deploying a deployment pipeline, according to at least one embodiment. In at least one embodiment, system 800 may be used to implement process 700 of FIG. 7 and/or other processes including advanced processing and inferencing pipelines. In at least one embodiment, system 800 may include training system 704 and deployment system 706. In at least one embodiment, training system 704 and deployment system 706 may be implemented using software 718, services 720, and/or hardware 722, as described herein.

In at least one embodiment, system 800 (e.g., training system 704 and/or deployment system 706) may implemented in a cloud computing environment (e.g., using cloud 826). In at least one embodiment, system 800 may be implemented locally with respect to a facility, or as a combination of both cloud and local computing resources. In at least one embodiment, access to APIs in cloud 826 may be restricted to authorized users through enacted security measures or protocols. In at least one embodiment, a security protocol may include web tokens that may be signed by an authentication (e.g., AuthN, AuthZ, Gluecon, etc.) service and may carry appropriate authorization. In at least one embodiment, APIs of virtual instruments (described herein), or other instantiations of system 800, may be restricted to a set of public internet service providers (ISPs) that have been vetted or authorized for interaction.

In at least one embodiment, various components of system 800 may communicate between and among one another using any of a variety of different network types, including but not limited to local area networks (LANs) and/or wide area networks (WANs) via wired and/or wireless communication protocols. In at least one embodiment, communication between facilities and components of system 800 (e.g., for transmitting inference requests, for receiving results of inference requests, etc.) may be communicated over a data bus or data busses, wireless data protocols (e.g., Wi-Fi), wired data protocols (e.g., Ethernet), etc.

In at least one embodiment, training system 704 may execute training pipelines 804, similar to those described herein with respect to FIG. 7. In at least one embodiment, where one or more machine learning models are to be used in deployment pipeline(s) 810 by deployment system 706, training pipeline(s) 804 may be used to train or retrain one or more (e.g., pre-trained) models, and/or implement one or more of pre-trained models 806 (e.g., without a need for retraining or updating). In at least one embodiment, as a result of training pipeline(s) 804, output model(s) 716 may be generated. In at least one embodiment, training pipeline(s) 804 may include any number of processing steps, AI-assisted annotation 710, labeling or annotating of feedback data 708 to generate labeled data 712, model selection from a model registry, model training 714, training, retraining, or updating models, and/or other processing steps. In at least one embodiment, DICOM adapter 802a can be used to access DICOM data. In at least one embodiment, for different machine learning models used by deployment system 706, different training pipeline(s) 804 may be used. In at least one embodiment, training pipeline(s) 804, similar to a first example described with respect to FIG. 7, may be used for a first machine learning model, training pipeline(s) 804, similar to a second example described with respect to FIG. 7, may be used for a second machine learning model, and training pipeline(s) 804, similar to a third example described with respect to FIG. 7, may be used for a third machine learning model. In at least one embodiment, any combination of tasks within training system 704 may be used depending on what is required for each respective machine learning model. In at least one embodiment, one or more of machine learning models may already be trained and ready for deployment so machine learning models may not undergo any processing by training system 704 and may be implemented by deployment system 706.

In at least one embodiment, output model(s) 716 and/or pre-trained models 806 may include any types of machine learning models depending on embodiment. In at least one embodiment, and without limitation, machine learning models used by system 800 may include machine learning model(s) using linear regression, logistic regression, decision trees, support vector machines (SVM), Naïve Bayes, k-nearest neighbor (Knn), K means clustering, random forest, dimensionality reduction algorithms, gradient boosting algorithms, neural networks (e.g., auto-encoders, convolutional, recurrent, perceptrons, Long/Short Term Memory (LSTM), Bi-LSTM, Hopfield, Boltzmann, deep belief, deconvolutional, generative adversarial, liquid state machine, etc.), and/or other types of machine learning models.

In at least one embodiment, training pipeline(s) 804 may include AI-assisted annotation. In at least one embodiment, labeled data 712 (e.g., traditional annotation) may be generated by any number of techniques. In at least one embodiment, labels or other annotations may be generated within a drawing program (e.g., an annotation program), a computer aided design (CAD) program, a labeling program, another type of program suitable for generating annotations or labels for ground truth, and/or may be hand drawn, in some examples. In at least one embodiment, ground truth data may be synthetically produced (e.g., generated from computer models or renderings), real produced (e.g., designed and produced from real-world data), machine-automated (e.g., using feature analysis and learning to extract features from data and then generate labels), human annotated (e.g., labeler, or annotation expert, defines location of labels), and/or a combination thereof. In at least one embodiment, for each instance of feedback data 708 (or other data type used by machine learning models), there may be corresponding ground truth data generated by training system 704. In at least one embodiment, AI-assisted annotation may be performed as part of deployment pipeline(s) 810; either in addition to, or in lieu of, AI-assisted annotation included in training pipeline(s) 804. In at least one embodiment, system 800 may include a multi-layer platform that may include a software layer (e.g., software 718) of diagnostic applications (or other application types) that may perform one or more medical imaging and diagnostic functions.

In at least one embodiment, a software layer may be implemented as a secure, encrypted, and/or authenticated API through which applications or containers may be invoked (e.g., called) from an external environment(s), e.g., facility 702. In at least one embodiment, applications may then call or execute one or more services 720 for performing compute, AI, or visualization tasks associated with respective applications, and software 718 and/or services 720 may leverage hardware 722 to perform processing tasks in an effective and efficient manner.

In at least one embodiment, deployment system 706 may execute deployment pipelines 810. In at least one embodiment, deployment pipeline(s) 810 may include any number of applications that may be sequentially, non-sequentially, or otherwise applied to feedback data (and/or other data types), including AI-assisted annotation, as described above. In at least one embodiment, as described herein, a deployment pipeline(s) 810 for an individual device may be referred to as a virtual instrument for a device. In at least one embodiment, for a single device, there may be more than one deployment pipeline(s) 810 depending on information desired from data generated by a device.

In at least one embodiment, applications available for deployment pipeline(s) 810 may include any application that may be used for performing processing tasks on feedback data or other data from devices. In at least one embodiment, because various applications may share common image operations, in some embodiments, a data augmentation library (e.g., as one of services 720) may be used to accelerate these operations. In at least one embodiment, to avoid bottlenecks of conventional processing approaches that rely on CPU processing, parallel computing platform 830 may be used for GPU acceleration of these processing tasks.

In at least one embodiment, deployment system 706 may include a user interface (UI) 814 (e.g., a graphical user interface, a web interface, etc.) that may be used to select applications for inclusion in deployment pipeline(s) 810, arrange applications, modify or change applications or parameters or constructs thereof, use and interact with deployment pipeline(s) 810 during set-up and/or deployment, and/or to otherwise interact with deployment system 706. In at least one embodiment, although not illustrated with respect to training system 704, UI 814 (or a different user interface) may be used for selecting models for use in deployment system 706, for selecting models for training, or retraining, in training system 704, and/or for otherwise interacting with training system 704.

In at least one embodiment, pipeline manager 812 may be used, in addition to an application orchestration system 828, to manage interaction between applications or containers of deployment pipeline(s) 810 and services 720 and/or hardware 722. In at least one embodiment, pipeline manager 812 may be configured to facilitate interactions from application to application, from application to service 720, and/or from application or service to hardware 722. In at least one embodiment, although illustrated as included in software 718, this is not intended to be limiting, and in some examples pipeline manager 812 may be included in services 720. In at least one embodiment, application orchestration system 828 (e.g., Kubernetes, DOCKER, etc.) may include a container orchestration system that may group applications into containers as logical units for coordination, management, scaling, and deployment. In at least one embodiment, by associating applications from deployment pipeline(s) 810 (e.g., a reconstruction application, a segmentation application, etc.) with individual containers, each application may execute in a self-contained environment (e.g., at a kernel level) to increase speed and efficiency.

In at least one embodiment, each application and/or container (or image thereof) may be individually developed, modified, and deployed (e.g., a first user or developer may develop, modify, and deploy a first application and a second user or developer may develop, modify, and deploy a second application separate from a first user or developer), which may allow for focus on, and attention to, a task of a single application and/or container(s) without being hindered by tasks of other application(s) or container(s). In at least one embodiment, communication, and cooperation between different containers or applications may be aided by pipeline manager 812 and application orchestration system 828. In at least one embodiment, so long as an expected input and/or output of each container or application is known by a system (e.g., based on constructs of applications or containers), application orchestration system 828 and/or pipeline manager 812 may facilitate communication among and between, and sharing of resources among and between, each of the applications or containers. In at least one embodiment, because one or more of applications or containers in deployment pipeline(s) 810 may share the same services and resources, application orchestration system 828 may orchestrate, load balance, and determine sharing of services or resources between and among various applications or containers. In at least one embodiment, a scheduler may be used to track resource requirements of applications or containers, current usage or planned usage of these resources, and resource availability. In at least one embodiment, the scheduler may thus allocate resources to different applications and distribute resources between and among applications in view of requirements and availability of a system. In some examples, the scheduler (and/or other component of application orchestration system 828) may determine resource availability and distribution based on constraints imposed on a system (e.g., user constraints), such as quality of service (QoS), urgency of need for data outputs (e.g., to determine whether to execute real-time processing or delayed processing), etc.

In at least one embodiment, services 720 leveraged and shared by applications or containers in deployment system 706 may include compute service(s) 816, collaborative content creation service(s) 817, AI service(s) 818, simulation service(s) 819, visualization service(s) 820, and/or other service types. In at least one embodiment, applications may call (e.g., execute) one or more of services 720 to perform processing operations for an application. In at least one embodiment, compute service(s) 816 may be leveraged by applications to perform super-computing or other high-performance computing (HPC) tasks. In at least one embodiment, compute service(s) 816 may be leveraged to perform parallel processing (e.g., using a parallel computing platform 830) for processing data through one or more of applications and/or one or more tasks of a single application, substantially simultaneously. In at least one embodiment, parallel computing platform 830 (e.g., NVIDIA's CUDA®) may enable general purpose computing on GPUs (GPGPU) (e.g., GPUs/graphics 822). In at least one embodiment, a software layer of parallel computing platform 830 may provide access to virtual instruction sets and parallel computational elements of GPUs, for execution of compute kernels. In at least one embodiment, parallel computing platform 830 may include memory and, in some embodiments, a memory may be shared between and among multiple containers and/or between and among different processing tasks within a single container. In at least one embodiment, inter-process communication (IPC) calls may be generated for multiple containers and/or for multiple processes within a container to use same data from a shared segment of memory of parallel computing platform 830 (e.g., where multiple different stages of an application or multiple applications are processing same information). In at least one embodiment, rather than making a copy of data and moving data to different locations in memory (e.g., a read/write operation), same data in the same location of a memory may be used for any number of processing tasks (e.g., at the same time, at different times, etc.). In at least one embodiment, as data is used to generate new data as a result of processing, this information of a new location of data may be stored and shared between various applications. In at least one embodiment, location of data and a location of updated or modified data may be part of a definition of how a payload is understood within containers.

In at least one embodiment, AI service(s) 818 may be leveraged to perform inferencing services for executing machine learning model(s) associated with applications (e.g., tasked with performing one or more processing tasks of an application). In at least one embodiment, AI service(s) 818 may leverage AI system(s) 824 to execute machine learning model(s) (e.g., neural networks, such as CNNs) for segmentation, reconstruction, object detection, feature detection, classification, and/or other inferencing tasks. In at least one embodiment, applications of deployment pipeline(s) 810 may use one or more of output model(s) 716 from training system 704 and/or other models of applications to perform inference on imaging data (e.g., DICOM data, RIS data, CIS data, REST compliant data, RPC data, raw data, etc.). For example, DICOM adapter 802b may be used to access DICOM data. In at least one embodiment, two or more examples of inferencing using application orchestration system 828 (e.g., a scheduler) may be available. In at least one embodiment, a first category may include a high priority/low latency path that may achieve higher service level agreements, such as for performing inference on urgent requests during an emergency, or for a radiologist during diagnosis. In at least one embodiment, a second category may include a standard priority path that may be used for requests that may be non-urgent or where analysis may be performed at a later time. In at least one embodiment, application orchestration system 828 may distribute resources (e.g., services 720 and/or hardware 722) based on priority paths for different inferencing tasks of AI service(s) 818.

In at least one embodiment, shared storage may be mounted to AI service(s) 818 within system 800. In at least one embodiment, shared storage may operate as a cache (or other storage device type) and may be used to process inference requests from applications. In at least one embodiment, when an inference request is submitted, a request may be received by a set of API instances of deployment system 706, and one or more instances may be selected (e.g., for best fit, for load balancing, etc.) to process a request. In at least one embodiment, to process a request, a request may be entered into a database, a machine learning model may be located from model registry 724 if not already in a cache, a validation step may ensure an appropriate machine learning model is loaded into a cache (e.g., shared storage), and/or a copy of a model may be saved to a cache. In at least one embodiment, the scheduler (e.g., of pipeline manager 812) may be used to launch an application that is referenced in a request if an application is not already running or if there are not enough instances of an application. In at least one embodiment, if an inference server is not already launched to execute a model, an inference server may be launched. In at least one embodiment, any number of inference servers may be launched per model. In at least one embodiment, in a pull model, in which inference servers are clustered, models may be cached whenever load balancing is advantageous. In at least one embodiment, inference servers may be statically loaded in corresponding, distributed servers.

In at least one embodiment, inferencing may be performed using an inference server that runs in a container. In at least one embodiment, an instance of an inference server may be associated with a model (and optionally a plurality of versions of a model). In at least one embodiment, if an instance of an inference server does not exist when a request to perform inference on a model is received, a new instance may be loaded. In at least one embodiment, when starting an inference server, a model may be passed to an inference server such that a same container may be used to serve different models so long as the inference server is running as a different instance.

In at least one embodiment, during application execution, an inference request for a given application may be received, and a container (e.g., hosting an instance of an inference server) may be loaded (if not already loaded), and a start procedure may be called. In at least one embodiment, pre-processing logic in a container may load, decode, and/or perform any additional pre-processing on incoming data (e.g., using a CPU(s) and/or GPU(s)). In at least one embodiment, once data is prepared for inference, a container may perform inference as necessary on data. In at least one embodiment, this may include a single inference call on one image (e.g., a hand X-ray), or may require inference on hundreds of images (e.g., a chest CT). In at least one embodiment, an application may summarize results before completing, which may include, without limitation, a single confidence score, pixel-level segmentation, voxel-level segmentation, generating a visualization, or generating text to summarize findings. In at least one embodiment, different models or applications may be assigned different priorities. For example, some models may have a real-time (turnaround time less than one minute) priority while others may have lower priority (e.g., turnaround less than 10 minutes). In at least one embodiment, model execution times may be measured from requesting institution or entity and may include partner network traversal time, as well as execution on an inference service.

In at least one embodiment, transfer of requests between services 720 and inference applications may be hidden behind a software development kit (SDK), and robust transport may be provided through a queue. In at least one embodiment, a request is placed in a queue via an API for an individual application/tenant ID combination and an SDK pulls a request from a queue and gives a request to an application. In at least one embodiment, a name of a queue may be provided in an environment from where an SDK picks up the request. In at least one embodiment, asynchronous communication through a queue may be useful as it may allow any instance of an application to pick up work as it becomes available. In at least one embodiment, results may be transferred back through a queue, to ensure no data is lost. In at least one embodiment, queues may also provide an ability to segment work, as highest priority work may go to a queue with most instances of an application connected to it, while lowest priority work may go to a queue with a single instance connected to it that processes tasks in an order received. In at least one embodiment, an application may run on a GPU-accelerated instance generated in cloud 826, and an inference service may perform inferencing on a GPU.

In at least one embodiment, visualization service(s) 820 may be leveraged to generate visualizations for viewing outputs of applications and/or deployment pipeline(s) 810. In at least one embodiment, GPUs/graphics 822 may be leveraged by visualization service(s) 820 to generate visualizations. In at least one embodiment, rendering effects, such as ray-tracing or other light transport simulation techniques, may be implemented by visualization service(s) 820 to generate higher quality visualizations. In at least one embodiment, visualizations may include, without limitation, 2D image renderings, 3D volume renderings, 3D volume reconstruction, 2D tomographic slices, virtual reality displays, augmented reality displays, etc. In at least one embodiment, virtualized environments may be used to generate a virtual interactive display or environment (e.g., a virtual environment) for interaction by users of a system (e.g., doctors, nurses, radiologists, etc.). In at least one embodiment, visualization service(s) 820 may include an internal visualizer, cinematics, and/or other rendering or image processing capabilities or functionality (e.g., ray tracing, rasterization, internal optics, etc.).

In at least one embodiment, hardware 722 may include GPUs/graphics 822, AI system(s) 824, cloud 826, and/or any other hardware used for executing training system 704 and/or deployment system 706. In at least one embodiment, GPUs/graphics 822 (e.g., NVIDIA's TESLA® and/or QUADRO® GPUs) may include any number of GPUs that may be used for executing processing tasks of compute service(s) 816, collaborative content creation service(s) 817, AI service(s) 818, simulation service(s) 819, visualization service(s) 820, other services, and/or any of features or functionality of software 718. For example, with respect to AI service(s) 818, GPUs/graphics 822 may be used to perform pre-processing on imaging data (or other data types used by machine learning models), post-processing on outputs of machine learning models, and/or to perform inferencing (e.g., to execute machine learning models). In at least one embodiment, cloud 826, AI system(s) 824, and/or other components of system 800 may use GPUs/graphics 822. In at least one embodiment, cloud 826 may include a GPU-optimized platform for deep learning tasks. In at least one embodiment, AI system(s) 824 may use GPUs, and cloud 826—or at least a portion tasked with deep learning or inferencing—may be executed using one or more AI system(s)s 824. As such, although hardware 722 is illustrated as discrete components, this is not intended to be limiting, and any components of hardware 722 may be combined with, or leveraged by, any other components of hardware 722.

In at least one embodiment, AI system(s) 824 may include a purpose-built computing system (e.g., a super-computer or an HPC) configured for inferencing, deep learning, machine learning, and/or other artificial intelligence tasks. In at least one embodiment, AI system(s) 824 (e.g., NVIDIA's DGX™) may include GPU-optimized software (e.g., a software stack) that may be executed using a plurality of GPUs/graphics 822, in addition to CPUs, RAM, storage, and/or other components, features, or functionality. In at least one embodiment, one or more AI system(s)s 824 may be implemented in cloud 826 (e.g., in a data center) for performing some or all of AI-based processing tasks of system 800.

In at least one embodiment, cloud 826 may include a GPU-accelerated infrastructure (e.g., NVIDIA's NGC™) that may provide a GPU-optimized platform for executing processing tasks of system 800. In at least one embodiment, cloud 826 may include an AI system(s) 824 for performing one or more of AI-based tasks of system 800 (e.g., as a hardware abstraction and scaling platform). In at least one embodiment, cloud 826 may integrate with application orchestration system 828 leveraging multiple GPUs to enable seamless scaling and load balancing between and among applications and services 720. In at least one embodiment, cloud 826 may be tasked with executing at least some of services 720 of system 800, including compute service(s) 816, AI service(s) 818, and/or visualization service(s) 820, as described herein. In at least one embodiment, cloud 826 may perform small and large batch inference (e.g., executing NVIDIA's TensorRT™), provide an accelerated parallel computing platform 830 (e.g., NVIDIA's CUDA®), execute application orchestration system 828 (e.g., KUBERNETES), provide a graphics rendering API and platform (e.g., for ray-tracing, 2D graphics, 3D graphics, and/or other rendering techniques to produce higher quality cinematics), and/or may provide other functionality for system 800. In at least one embodiment, parallel computing platform 830 may include an API.

In at least one embodiment, in an effort to preserve patient confidentiality (e.g., where patient data or records are to be used off-premises), cloud 826 may include a registry, such as a deep learning container registry. In at least one embodiment, a registry may store containers for instantiations of applications that may perform pre-processing, post-processing, or other processing tasks on patient data. In at least one embodiment, cloud 826 may receive data that includes patient data as well as sensor data in containers, perform requested processing for just sensor data in those containers, and then forward a resultant output and/or visualizations to appropriate parties and/or devices (e.g., on-premises medical devices used for visualization or diagnoses), all without having to extract, store, or otherwise access patient data. In at least one embodiment, confidentiality of patient data is preserved in compliance with HIPAA and/or other data regulations.

Other variations are within the spirit of present disclosure. Thus, while disclosed techniques are susceptible to various modifications and alternative constructions, certain illustrated embodiments thereof are shown in drawings and have been described above in detail. It should be understood, however, that there is no intention to limit disclosure to specific form or forms disclosed, but on contrary, intention is to cover all modifications, alternative constructions, and equivalents falling within spirit and scope of disclosure, as defined in appended claims.

Use of terms “a” and “an” and “the” and similar referents in context of describing disclosed embodiments (especially in context of following claims) are to be construed to cover both singular and plural, unless otherwise indicated herein or clearly contradicted by context, and not as a definition of a term. Terms “comprising,” “having,” “including,” and “containing” are to be construed as open-ended terms (meaning “including, but not limited to,”) unless otherwise noted. “Connected,” when unmodified and referring to physical connections, is to be construed as partly or wholly contained within, attached to, or joined together, even if there is something intervening. Recitation of ranges of values herein are merely intended to serve as a shorthand method of referring individually to each separate value falling within range, unless otherwise indicated herein and each separate value is incorporated into specification as if it were individually recited herein. In at least one embodiment, use of the term “set” (e.g., “a set of items”) or “subset” unless otherwise noted or contradicted by context, is to be construed as a nonempty collection comprising one or more members. Further, unless otherwise noted or contradicted by context, the term “subset” of a corresponding set does not necessarily denote a proper subset of the corresponding set, but subset and corresponding set may be equal.

Conjunctive language, such as phrases of form “at least one of A, B, and C,” or “at least one of A, B and C,” unless specifically stated otherwise or otherwise clearly contradicted by context, is otherwise understood with context as used in general to present that an item, term, etc., may be either A or B or C, or any nonempty subset of set of A and B and C. For instance, in illustrative example of a set having three members, conjunctive phrases “at least one of A, B, and C” and “at least one of A, B and C” refer to any of following sets: {A}, {B}, {C}, {A, B}, {A, C}, {B, C}, {A, B, C}. Thus, such conjunctive language is not generally intended to imply that certain embodiments require at least one of A, at least one of B and at least one of C each to be present. In addition, unless otherwise noted or contradicted by context, the term “plurality” indicates a state of being plural (e.g., “a plurality of items” indicates multiple items). In at least one embodiment, a number of items in a plurality is at least two but can be more when so indicated either explicitly or by context. Further, unless stated otherwise or otherwise clear from context, the phrase “based on” means “based at least in part on” or “based at least on” and not “based solely on.”

Operations of processes described herein can be performed in any suitable order unless otherwise indicated herein or otherwise clearly contradicted by context. In at least one embodiment, a process such as those processes described herein (or variations and/or combinations thereof) is performed under control of one or more computer systems configured with executable instructions and is implemented as code (e.g., executable instructions, one or more computer programs or one or more applications) executing collectively on one or more processors, by hardware or combinations thereof. In at least one embodiment, code is stored on a computer-readable storage medium, for example, in the form of a computer program comprising a plurality of instructions executable by one or more processors. In at least one embodiment, a computer-readable storage medium is a non-transitory computer-readable storage medium that excludes transitory signals (e.g., a propagating transient electric or electromagnetic transmission) but includes non-transitory data storage circuitry (e.g., buffers, cache, and queues) within transceivers of transitory signals. In at least one embodiment, code (e.g., executable code or source code) is stored on a set of one or more non-transitory computer-readable storage media having stored thereon executable instructions (or other memory to store executable instructions) that, when executed (i.e., as a result of being executed) by one or more processors of a computer system, cause computer system to perform operations described herein. In at least one embodiment, set of non-transitory computer-readable storage media comprises multiple non-transitory computer-readable storage media and one or more of individual non-transitory storage media of multiple non-transitory computer-readable storage media lack all of code while multiple non-transitory computer-readable storage media collectively store all of code. In at least one embodiment, executable instructions are executed such that different instructions are executed by different processors —for example, a non-transitory computer-readable storage medium store instructions and a main central processing unit (“CPU”) executes some of instructions while a graphics processing unit (“GPU”) executes other instructions. In at least one embodiment, different components of a computer system have separate processors and different processors execute different subsets of instructions.

Accordingly, in at least one embodiment, computer systems are configured to implement one or more services that singly or collectively perform operations of processes described herein and such computer systems are configured with applicable hardware and/or software that enable performance of operations. Further, a computer system that implements at least one embodiment of present disclosure is a single device and, in another embodiment, is a distributed computer system comprising multiple devices that operate differently such that distributed computer system performs operations described herein and such that a single device does not perform all operations.

Use of any and all examples, or exemplary language (e.g., “such as”) provided herein, is intended merely to better illuminate embodiments of disclosure and does not pose a limitation on scope of disclosure unless otherwise claimed. No language in specification should be construed as indicating any non-claimed element as essential to practice of disclosure.

All references, including publications, patent applications, and patents, cited herein are hereby incorporated by reference to the same extent as if each reference were individually and specifically indicated to be incorporated by reference and were set forth in its entirety herein.

In description and claims, terms “coupled” and “connected,” along with their derivatives, may be used. It should be understood that these terms may be not intended as synonyms for each other. Rather, in particular examples, “connected” or “coupled” may be used to indicate that two or more elements are in direct or indirect physical or electrical contact with each other. “Coupled” may also mean that two or more elements are not in direct contact with each other, but yet still co-operate or interact with each other.

Unless specifically stated otherwise, in some embodiments, it may be appreciated that throughout specification terms such as “processing,” “computing,” “calculating,” “determining,” or like, refer to action and/or processes of a computer or computing system, or similar electronic computing device, that manipulate and/or transform data represented as physical, such as electronic, quantities within computing system's registers and/or memories into other data similarly represented as physical quantities within computing system's memories, registers or other such information storage, transmission or display devices.

In a similar manner, the term “processor” may refer to any device or portion of a device that processes electronic data from registers and/or memory and transforms that electronic data into other electronic data that may be stored in registers and/or memory. As non-limiting examples, “processor” may be a CPU or a GPU. A “computing platform” may comprise one or more processors. As used herein, “software” processes may include, for example, software and/or hardware entities that perform work over time, such as tasks, threads, and intelligent agents. Also, each process may refer to multiple processes, for carrying out instructions in sequence or in parallel, continuously or intermittently. In at least one embodiment, terms “system” and “method” are used herein interchangeably insofar as a system may embody one or more methods and methods may be considered a system.

In the present document, references may be made to obtaining, acquiring, receiving, or inputting analog or digital data into a subsystem, computer system, or computer-implemented machine. In at least one embodiment, a process of obtaining, acquiring, receiving, or inputting analog and digital data can be accomplished in a variety of ways such as by receiving data as a parameter of a function call or a call to an application programming interface. In at least one embodiment, processes of obtaining, acquiring, receiving, or inputting analog or digital data can be accomplished by transferring data via a serial or parallel interface. In at least one embodiment, processes of obtaining, acquiring, receiving, or inputting analog or digital data can be accomplished by transferring data via a computer network from providing entity to acquiring entity. In at least one embodiment, references may also be made to providing, outputting, transmitting, sending, or presenting analog or digital data. In various examples, processes of providing, outputting, transmitting, sending, or presenting analog or digital data can be accomplished by transferring data as an input or output parameter of a function call, a parameter of an application programming interface or interprocess communication mechanism.

Although descriptions herein set forth example embodiments of described techniques, other architectures may be used to implement described functionality, and are intended to be within scope of this disclosure. Furthermore, although specific distributions of responsibilities may be defined above for purposes of description, various functions and responsibilities might be distributed and divided in different ways, depending on circumstances.

Furthermore, although subject matter has been described in language specific to structural features and/or methodological acts, it is to be understood that subject matter claimed in appended claims is not necessarily limited to specific features or acts described. Rather, specific features and acts are disclosed as exemplary forms of implementing the claims.

What is claimed is:

1. A method comprising:
executing a first task by a processor in a first mode, wherein the processor has a first memory configuration;
receiving, at a hardware controller operatively coupled to the processor, a second task with memory metadata;
determining a second memory configuration of the processor based on the memory metadata and the first memory configuration of the processor;
reconfiguring a memory of the processor based on the second memory configuration; and
executing the second task by the processor in the first mode.

2. The method of claim 1, wherein the first mode is at least one of a compute-in-graphics mode or an all-compute mode.

3. The method of claim 1, wherein the reconfiguring the memory of the processor is responsive to a reconfiguration trigger.

4. The method of claim 1, wherein the memory metadata comprises a minimum memory allocation, a target memory allocation, and a maximum memory allocation, and wherein the determining the second memory configuration based on the memory metadata comprises:
comparing the first memory configuration of the processor to the minimum memory allocation and the maximum memory allocation; and
responsive to the first memory configuration of the processor being outside of the minimum memory allocation and outside of the maximum memory allocation, setting the second memory configuration of the processor to have the target memory allocation.

5. The method of claim 1, wherein the memory metadata comprises a minimum memory allocation, a target memory allocation, and a maximum memory allocation, and wherein the determining the second memory configuration based on the memory metadata comprises:
comparing the first memory configuration of the processor to the minimum memory allocation and the maximum memory allocation; and
responsive to the first memory configuration of the processor being between the minimum memory allocation and the maximum memory allocation, setting the second memory configuration to have the first memory configuration.

6. The method of claim 2, wherein the first mode is the compute-in-graphics mode and the second memory configuration comprises a graphics-related random access memory (RAM) portion, a tagged level 1 (L1) portion, and an untagged L1 portion.

7. The method of claim 6, wherein the graphics-related RAM portion is a triangle random access memory (TRAM) portion.

8. The method of claim 2, wherein the first mode is the all-compute mode and the second memory configuration comprises a tagged level 1 (L1) portion and an untagged L1 portion.

9. A system comprising:
one or more processing devices to perform operations comprising:
executing a first task by a first processing device of the one or more processing devices in a first mode, wherein the first processing device has a first memory configuration;
receiving, at a hardware controller operatively coupled to the first processing device, a second task with memory metadata;
determining a second memory configuration of the first processing device based on the memory metadata and the first memory configuration of the first processing device;
reconfiguring a memory of the first processing device based on the second memory configuration; and
executing the second task by the first processing device in the first mode.

10. The system of claim 9, wherein the first mode is at least one of a compute-in-graphics mode or an all-compute mode.

11. The system of claim 9, wherein the reconfiguring the memory of the first processing device is responsive to a reconfiguration trigger.

12. The system of claim 9, wherein the memory metadata comprises a minimum memory allocation, a target memory allocation, and a maximum memory allocation, and wherein the determining the second memory configuration based on the memory metadata comprises:
comparing the first memory configuration of the first processing device to the minimum memory allocation and the maximum memory allocation; and
responsive to the first memory configuration of the first processing device being outside of the minimum memory allocation and outside of the maximum memory allocation, setting the second memory configuration of the first processing device to have the target memory allocation.

13. The system of claim 9, wherein the memory metadata comprises a minimum memory allocation, a target memory allocation, and a maximum memory allocation, and wherein the determining the second memory configuration based on the memory metadata comprises:
comparing the first memory configuration of the first processing device to the minimum memory allocation and the maximum memory allocation; and
responsive to the first memory configuration of the first processing device being between the minimum memory allocation and outside of the maximum memory allocation, setting the second memory configuration of the first processing device to have the first memory configuration.

14. The system of claim 10, wherein the first mode is the compute-in-graphics mode and the second memory configuration comprises a graphics-related random access memory (RAM) portion, a tagged level 1 (L1) portion, and an untagged L1 portion.

15. The system of claim 14, wherein the graphics-related RAM portion is a triangle random access memory (TRAM) portion.

16. The system of claim 10, wherein the first mode is the all-compute mode and the second memory configuration comprises a tagged level 1 (L1) portion and an untagged L1 portion.

17. A processor comprising one or more processing units to:
execute a first task in a first mode, wherein the processor has a first memory configuration;
receive a second task with memory metadata;
determine a second memory configuration of the processor based on the memory metadata and the first memory configuration of the processor;
reconfigure a memory of the processor based on the second memory configuration; and
execute the second task in the first mode.

18. The processor of claim 17, wherein the first mode is at least one of a compute-in-graphics mode or an all-compute mode.

19. The processor of claim 17, wherein reconfiguring the memory of the processor is responsive to a reconfiguration trigger.

20. The processor of claim 17, wherein the memory metadata comprises a minimum memory allocation, a target memory allocation, and a maximum memory allocation, and wherein to determine the second memory configuration based on the memory metadata, the one or more processing units are to:
compare the first memory configuration of the processor to the minimum memory allocation and the maximum memory allocation; and
responsive to the first memory configuration of the processor being outside of the minimum memory allocation and outside of the maximum memory allocation, set the second memory configuration of the processor to have the target memory allocation.

21. The processor of claim 17, wherein the memory metadata comprises a minimum memory allocation, a target memory allocation, and a maximum memory allocation, and wherein to determine the second memory configuration based on the memory metadata, the one or more processing units are to:
compare the first memory configuration of the processor to the minimum memory allocation and the maximum memory allocation; and
responsive to the first memory configuration of the processor being between the minimum memory allocation and outside of the maximum memory allocation, set the second memory configuration of the processor to have the first memory configuration.

22. The processor of claim 18, wherein the first mode is the compute-in-graphics mode and the second memory configuration comprises a graphics-related random access memory (RAM) portion, a tagged level 1 (L1) portion, and an untagged L1 portion.

23. The processor of claim 22, wherein the graphics-related RAM portion is a triangle random access memory (TRAM) portion.

24. The processor of claim 18, wherein the first mode is the all-compute mode and the second memory configuration comprises a tagged level 1 (L1) portion and an untagged L1 portion.
